(19) United States
(12) Patent Application Publication
(10) Pub. No.: US 2020/0129922 A1
(43) Pub. Date: Apr. 30, 2020

(54) METHOD OF REDUCING CONCENTRATION OF FLUORINE-CONTAINING COMPOUND IN SAMPLE

(71) Applicant: Samsung Electronics Co., Ltd., Suwon-si (KR)

(72) Inventors: Dongsik Yang, Seoul (KR); Taeyong Kim, Daejeon (KR); Jinsuk Lee, Suwon-si (KR); Yukyung Jung, Hwaseong-si (KR); Seunghoon Song, Suwon-si (KR)

(21) Appl. No.: 16/410,965

(22) Filed: May 13, 2019

(30) Foreign Application Priority Data
Oct. 29, 2018 (KR) 10-2018-0130244

(51) Int. Cl. B01D 53/84; B01D 53/78; B01D 53/86; C02F 3/34

(52) U.S. Cl. CPC B01D 53/84; B01D 53/78; B01D 53/8662; C02F 3/342; C02F 2101/36; B01D 2257/2066; B01D 2255/804; B01D 2251/95; C02F 3/341

(57) ABSTRACT

Provided is a method of reducing a concentration of a fluorine-containing compound in a sample using a biocatalyst and an ionic liquid.

### CROSS-REFERENCE TO RELATED APPLICATION

This application claims the benefit of Korean Patent Application No. 10-2018-0130244, filed on Oct. 29, 2018, in the Korean Intellectual Property Office, the entire disclosure of which is incorporated herein by reference.

### BACKGROUND

### 1. Field

The present disclosure relates to a method of reducing a concentration of a fluorine-containing compound in a sample.

### 2. Description of the Related Art

The emission of greenhouse gases which have accelerated global warming is a serious environmental problem, and regulations to reduce and prevent the emission of greenhouse gases have been tightened. Among the greenhouse gases, fluorinated gases (F-gas) such as perfluorocarbons (PFCs), hydrofluorocarbons (HFCs), or sulfur hexafluoride (SF₆) show low absolute emission, but have a long half-life and a very high global warming potential, resulting in significant adverse environmental impacts. F-gas emissions from the semiconductor and electronics industries, have exceeded greenhouse gas emission quotas and continue to increase. Therefore, costs required for degradation of greenhouse gases and greenhouse gas emission allowances are increasing every year.

In general, a pyrolytic or catalytic thermal oxidation process has been used in the decomposition of F-gas. However, this process has disadvantages of a limited decomposition rate, emission of secondary pollutants, high cost, etc. To help solve these problems, biological decomposition of F-gas using a microbial biocatalyst has been adopted. The use of such microbial biocatalysts is expected to overcome the limitations of known chemical decomposition processes and to treat F-gas in more economical and environmentally-friendly manner.

Despite such efforts, there is still a need for an alternative method to increase efficiency in reducing a concentration of fluorinated gas in a sample using a biocatalyst.

### SUMMARY

Provided is a method of reducing a concentration of a fluorine-containing compound in a sample, the method including contacting a biological catalyst with the sample containing the fluorine-containing compound in the presence of an ionic liquid to reduce the concentration of the fluorine-containing compound in the sample.

### BRIEF DESCRIPTION OF THE DRAWINGS

These and/or other aspects will become apparent and more readily appreciated from the following description of the embodiments, taken in conjunction with the accompanying drawing in which:

FIG. 1 is a schematic illustration of a glass Dimroth spiral condenser.

### DETAILED DESCRIPTION

An aspect provides a method of reducing a concentration of a fluorine-containing compound in a sample, the method including contacting a biological catalyst with the sample containing the fluorine-containing compound in the presence of an ionic liquid to reduce the concentration of the fluorine-containing compound in the sample.

With regard to the method, the ionic liquid is an organic compound that is a liquid at room temperature, i.e., at about 25° C. These ionic liquids differ from most salts in that they have a very low melting point, tend to be in a liquid state over a wide temperature range, and have a high heat capacity. The ionic liquids intrinsically have no vapor pressure, and they may be neutral, acidic, or basic. Properties of the ionic liquids may be tailored by switching cations and anions. In principle, cations and anions of the ionic liquid useful in the present disclosure may be any cations or anions that may form organic salts in liquid phases below about 100° C. A “fluorinated ionic liquid” is an ionic liquid having one or more fluorines on either the cation or the anion. A “fluorinated cation” or “fluorinated anion” is a cation or anion, respectively, including one or more fluorines.

Solubility of the fluorine-containing compound in the ionic liquid may be 300 mg/l or more, 350 mg/l or more, 361.6 mg/l or more, 400 mg/l or more, 450 mg/l or more, or 500 mg/l or more at 30° C. The solubility of the fluorine-containing compound in the ionic liquid may be higher than solubility of the fluorine-containing compound in an aqueous liquid, e.g., water. The solubility of the fluorine-containing compound in the ionic liquid may be 10%, 20%, 30%, 40%, 50%, 60%, 70%, 80%, 90%, 100%, 150%, 200%, 500%, 1000%, 5000%, 10,000%, 15,000%, 20,000%, 25,000%, or 30,000% higher than the solubility of the fluorine-containing compound in an aqueous liquid, e.g., water. For example, the solubility of CF₄ in water is 17.1 mg/l at 30° C. The solubility of CF₄ in the ionic liquid may be 10%, 20%, 30%, 40%, 50%, 60%, 70%, 80%, 90%, 100%, 150%, 200%, 500%, 1000%, 5000%, 10,000%, 15,000%, 20,000%, 25,000%, or 30,000% higher than the solubility of CF₄ in an aqueous liquid, e.g., water. For example, the solubility of CF₄ in the ionic liquid is 300 mg/l or more, 350 mg/l or more, 361.6 mg/l or more, 400 mg/l or more, 450 mg/l or more, or 500 mg/l or more at 30° C.

In some embodiments, the ionic liquid may include a cation selected from the group consisting of the following 11 kinds of cations:

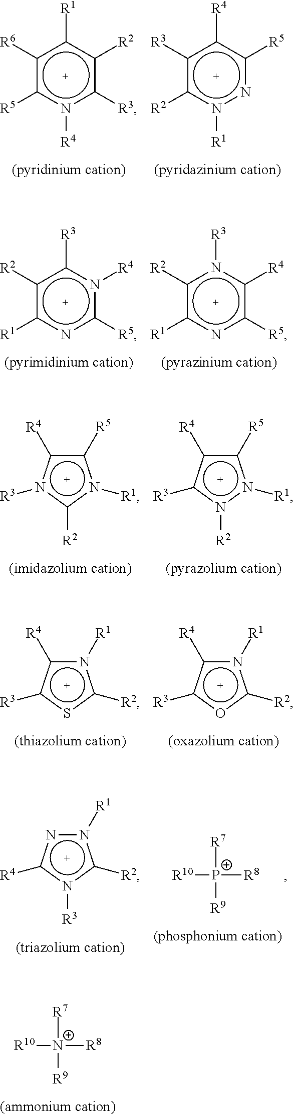

wherein, in the above formulae, R¹, R², R³, R⁴, R⁵, and R⁶ may be each independently selected from the group consisting of:

(i) H,

(ii) a halogen,

(iii) a —CH₃, —C₂H₅, or C3 to C25 (e.g., C3 to C22, C3 to C20, or C3 to C18) linear, branched, or cyclic alkane or alkene optionally substituted with one or more selected from the group consisting of Cl, Br, F, I, OH, NH₂, and SH,

(iv) a —CH₃, —C₂H₅, or C3 to C25 (e.g., C3 to C22, C3 to C20, or C3 to C18) linear, branched, or cyclic alkane or alkene including 1 to 3 heteroatoms (i.e., heteroalkene or heteroalkene) selected from the group consisting of O, N, Si, and S, and optionally substituted with one or more selected from the group consisting of Cl, Br, F, I, OH, NH₂, and SH,

(v) a C6 to C20 (e.g., C6 to C22, C6 to C20, or C6 to C18) unsubstituted aryl group, or a C3 to C25 (e.g., C3 to C22, C3 to C20, or C3 to C18) unsubstituted heteroaryl group having 1 to 3 heteroatoms independently selected from the group consisting of O, N, Si, and S, and

(vi) a C6 to C25 (e.g., C6 to C22, C6 to C20, or C6 to C18) substituted aryl group, or a C3 to C25 (e.g., C3 to C22, C3 to C20, or C3 to C18) substituted heteroaryl group having 1 to 3 heteroatoms independently selected from the group consisting of O, N, Si, and S, wherein the substituted aryl group or the substituted heteroaryl group has one to three substituents independently selected from the group consisting of (1) a —CH₃, —C₂H₅, or C3 to C25 (e.g., C3 to C22, C3 to C20, or C3 to C18) linear, branched, or cyclic alkane or alkene optionally substituted with one or more selected from the group consisting of Cl, Br, F, I, OH, NH₂, and SH, (2) OH, (3) NH₂, and (4) SH;

R⁷, R⁸, R⁹, and R¹⁰ may be each independently selected from the group consisting of:

(vii) a —CH₃, —C₂H₅, or C3 to C25 (e.g., C3 to C22, C3 to C20, or C3 to C18) linear, branched, or cyclic alkane or alkene optionally substituted with one or more selected from the group consisting of Cl, Br, F, I, OH, NH₂, and SH,

(viii) a —CH₃, —C₂H₅, or C3 to C25 (e.g., C3 to C22, C3 to C20, or C3 to C18) linear, branched, or cyclic alkane or alkene including one to three heteroatoms selected from the group consisting of O, N, Si, and S, and is optionally substituted with one or more selected from the group consisting of Cl, Br, F, I, OH, NH₂, and SH,

(ix) a C6 to C25 (e.g., C6 to C22, C6 to C20, or C6 to C18) unsubstituted aryl group, or C3 to C25 (e.g., C3 to C22, C3 to C20, or C3 to C18) unsubstituted heteroaryl group having 1 to 3 heteroatoms independently selected from the group consisting of O, N, Si, and S, and

(x) a C6 to C25 (e.g., C6 to C22, C6 to C20, or C6 to C18) substituted aryl group, or a C3 to C25 (e.g., C3 to C22, C3 to C20, or C3 to C18) substituted heteroaryl group having 1 to 3 heteroatoms independently selected from the group consisting of O, N, Si, and S, wherein the substituted aryl group or the substituted heteroaryl group has one to three substituents independently selected from the group consisting of (1) a —CH₃, —C₂H₅, or C3 to C25 (e.g., C3 to C22, C3 to C20, or C3 to C18) linear, branched, or cyclic alkane or alkene optionally substituted with one or more selected from the group consisting of Cl, Br, F, I, OH, NH₂, and SH, (2) OH, (3) NH₂, and (4) SH; and

any two or more of R¹, R², R³, R⁴, R⁵, R⁶, R⁷, R⁸, R⁹, and R¹⁰ optionally may form a cyclic or bicyclic alkanyl or alkenyl group.

In some embodiments, the ionic liquid includes a phosphonium cation. In the phosphonium cation, R⁷, R⁸, R⁹, and R¹⁰ may each independently be —CH₃, —C₂H₅, or C3 to C25, C3 to C22, C3 to C20, or C3 to C18 linear, branched, or cyclic alkane or alkene optionally substituted with one or more selected from the group consisting of Cl, Br, F, I, OH, NH₂, and SH. In some embodiments, R⁷, R⁸, R⁹, and R¹⁰ may each independently be C1 to C25, C1 to C22, C1 to C18, C1 to C16, C2 to C22, C2 to C18, C2 to C16, or C2 to C18 linear or branched alkane or alkene optionally substituted with one or more selected from the group consisting of Cl, Br, F, I, OH, NH₂, and SH. In still further embodiments, any three of the substituents R⁷, R⁸, R⁹, and R¹⁰ may each independently be —CH₃, —C₂H₅, or C3 to C6, C3 to C5, or C3 to C4 linear, branched, or cyclic alkane or alkene optionally substituted with one or more selected from the group consisting of Cl, Br, F, I, OH, NH₂, and SH, and the remaining substituent of the substituents R⁷, R⁸, R⁹, and R¹⁰ may be C7 to C24, C7 to C22, C7 to C20, C7 to C18, or C7 to C16 linear, branched, or cyclic alkane or alkene optionally substituted with one or more selected from the group consisting of Cl, Br, F, I, OH, NH₂, and SH.

The ionic liquid may include any suitable anion, such as an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]—, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion.

In some embodiments, the ionic liquid may include an anion selected from the group consisting of [BF_{4]}⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

In some embodiments, the ionic liquid may include a cation selected from the group consisting of pyridinium, pyridazinium, pyrimidinium, pyrazinium, imidazolium, pyrazolium, thiazolium, oxazolium, triazolium, phosphonium, and ammonium ions; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

In some embodiments, the ionic liquid may include a phosphonium cation and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻. The ionic liquid may include, for example, a cation consisting of a phosphonium ion and an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

The ionic liquid may include, for example, a phosphonium cation and an anion of [(CF₃CF₂SO₂)₂N]⁻.

More specific illustrative examples of ionic liquids include, without limitation, triethyl pentyl phosphonium bis(trifluoromethylsulfonyl)imide (P₂₂₂₅⁺NTf₂⁻), triethyl octyl phosphonium bis(trifluoromethylsulfonyl)imide (P₂₂₂₈⁺NTf₂⁻), trihexyl tetradecyl phosphonium bis(trifluoromethylsulfonyl)imide (P₆₆₆₁₄⁺NTf₂⁻), tri-n-butyl methyl phosphonium bis(trifluoromethylsulfonyl)imide (P₄₄₄₁⁺NTf₂⁻), triethyl(methoxymethyl) phosphonium bis(trifluoromethylsulfonyl)imide (P_{222(1O1)}⁺NTf₂⁻), 1-butyl-3-methylimidazolium hexafluorophosphate [bmim][PF₆], 1-butyl-3-methylimidazolium tetrafluoroborate [bmim][BF₄], 1,2-dimethyl-3-propylimidazolium tris(trifluoromethylsulfonyl)methide [dmpim][TMeM], 1-octyl-3-methylimidazolium iodide [omim][I], 1,3-dioctylimidazolium iodide [doim][I], 1-ethyl-3-methylimidazolium bis(pentafluoroethylsulfonyl)imide [emim][BEI], 1,2-dimethyl-3-propylimidazolium bis(trifluoromethylsulfonyl)imide [dmpim][BMeI], 3-methyl-1-propylpyridinium bis(trifluoromethylsulfonyl)imide [pmpy][BMeI], 1-ethyl-3-methylimidazolium hexafluorophosphate [emim][PF₆], 1-ethyl-3-methylimidazolium bis(trifluoroethylsulfonyl)imide [emim][BMeI], 1-butyl-3-methylpyridinium bis(trifluoromethylsulfonyl)imide [bmpy][BMeI], 1-ethyl-3-methylimidazolium 1,1,2,2-tetrafluoroethanesulfonate [emim][TFES], 1-butyl-3-methylimidazolium 1,1,2,2-tetrafluoroethanesulfonate [bmim][TFES], 1-dodecyl-3-methylimidazolium 1,1,2,2-tetrafluoroethanesulfonate [dmim][TFES], 1-heptyl-3-methylimidazolium 1,1,2,2-tetrafluoroethanesulfonate [hmim][TFES], 1-butyl-3-methylimidazolium acetate [bmim][Ac], 1-butyl-3-methylimidazolium 2-(1,2,2,2-tetrafluoroethoxy)-1,1,2,2-tetrafluoroethanesulfonate [bmim][FS], 1-butyl-3-methylimidazolium 1,1,2,3,3,3-hexafluoropropanesulfonate [bmim][HFPS], 1-butyl-3-methylimidazolium methylsulfonate [bmim][MeSO₄], 1-butyl-3-methylimidazolium thiocyanate [bmim][SCN], 1-butyl-3-methylimidazolium 1,1,2-trifluoro-2-(perfluoroethoxy)ethanesulfonate [bmim][TPES], 1-butyl-3-methylimidazolium 1,1,2-trifluoro-2-(trifluoromethoxy)ethanesulfonate [bmim][TTES], 1-butyl-3-methylimidazolium 1,1,2-trifluoro-2-(trifluoromethoxy)ethanesulfonate [bmim][TTES], 1-butyl-3-methylimidazolium 1,1,2-trifluoro-2-(perfluoroethoxy)ethanesulfonate [bmim][TPES], 1-ethyl-3-methylimidazolium bis(pentafluoroethylsulfonyl)imide[emim][BEI], 1-butyl-3-methylimidazolium 1,1,2,3,3-hexafluoropropanesulfonate [bmim][HFPS], tetradecyl(trihexyl)phosphonium 1,1,2-trifluoro-2-(perfluoroethoxy)ethanesulfonate [6,6,6,14-P][TPES], and tributyl(tetradecyl)phosphonium 1,1,2,3,3,3-hexafluoropropanesulfonate [4,4,4,14-P][HFPS].

The ionic liquid may include triethyl pentyl phosphonium bis(trifluoromethylsulfonyl)imide, triethyl octyl phosphonium bis(trifluoromethylsulfonyl)imide, trihexyl tetradecyl phosphonium bis(trifluoromethylsulfonyl)imide, tri-n-butyl methyl phosphonium bis(trifluoromethylsulfonyl)imide, or triethyl(methoxymethyl) phosphonium bis(trifluoromethylsulfonyl)imide; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F—.

In some embodiments, the ionic liquid may include triethyl octyl phosphonium bis(trifluoromethylsulfonyl)imide, tributyl methyl phosphonium bis(trifluoromethylsulfonyl)imide, or trihexyl tetradecyl phosphonium bis(trifluoromethylsulfonyl)imide; and [(CF₃SO₂)₂N]⁻. Any combination of ionic liquids described herein also may be used.

In the present disclosure, when referring to an alkane, alkene, alkoxy, fluoroalkoxy, perfluoroalkoxy, fluoroalkyl, perfluoroalkyl, aryl, or heteroaryl radical or residue, the phrase “optionally substituted with one or more selected from the group consisting of” means that one or more hydrogens on the carbon chain of the radical or residue may be independently substituted with one or more of the mentioned substituents. For example, a —C₂H₅ radical or residue substituted with one or more F, I, or OH groups would include, without limitation, —CF₂CF₃, —CH₂CH₂OH or —CF₂CF₂I.

With regard to the method, the biological catalyst may be an enzyme or a microorganism. When the biological catalyst is in contact with a sample containing a fluorine-containing compound, the biological catalyst may have an ability to reduce a concentration of the fluorine-containing compound in the sample. The enzyme or microorganism may catalyze conversion of the fluorine-containing compound as a substrate into other chemicals. The enzyme or microorganism may catalyze a modification of the fluorine-containing compound whereby a C—F or S—F bond is cleaved, or whereby a C—F or S—F bond is disrupted by introduction of a group such as a hydroxyl group. The enzyme may be, for example, a dehalogenase, and the microorganism may be a microorganism that expresses a dehalogenase. The dehalogenase may be any dehalogenase capable of reducing a fluorine-containing compound in a sample, for example, 4-chlorobenzoate dehalogenase, 4-chlorobenzoyl-CoA dehalogenase, dichloromethane dehalogenase, fluoroacetate dehalogenase, haloacetate dehalogenase, (R)-2-haloacid dehalogenase, (S)-2-haloacid dehalogenase, haloalkane dehalogenase, halohydrin dehalogenase, or tetrachloroethene reductive dehalogenase. The enzyme may be selected from the group consisting of 2-haloacid dehalogenase (HAD), haloalakane dehalogenase, soluble monooxygenase, and bacterial cytochrome P450. The microorganism may include a gene encoding the enzyme to express the enzyme. The microorganism may be a recombinant microorganism including the gene, wherein the gene is endogenous or heterologous. In some embodiments, the micoorganism has been modified to increase expression of the gene, such as by introducing a nucleic acid encoding the gene into the microorganism, thereby increasing the copy number of the gene in the microorganism.

in some embodiments, the microorganism may be a bacterium. Examples of suitable bacterium include a microorganism belonging to the genus Pseudomonas, Xanthobacter, Escherichia, or Bacillus. For example, the microorganism may be Pseudomonas saitens SF1 (Accession No: KCTC 13107BP), Pseudomonas putida, Xanthobacter autotrophicus, Escherichia coli, Bacillus megaterium, Bacillus bombysepticus SF3 strain (Accession No: KCTC13220BP), or Bacillus saitens (Accession No: KCTC 132198P).

With regard to the method, the fluorine-containing compound may be a compound represented by any one of the following Formulae 1 to 3:

C(R¹)(R²)(R³)(R⁴) <Formula 1>

(R⁵)(R⁶)(R⁷)C—[C(R¹¹)(R¹²)]ₙ—C(R⁸)(R⁹)(R¹⁰) <Formula 2>

S(R¹³)(R¹⁴)(R¹⁵)(R¹⁶)(R¹⁷)(R¹⁸) <Formula 3>

in the above formulae, n is an integer of 0 to 10 and, when n is an integer of 2 to 10, each instance of R¹¹ may be the same as or different from each other, and each instance of R¹² may be the same as or different from each other,

in Formula 1, R¹, R², R³ and R⁴ may be each independently F, Cl, Br, I, or H, provided thatone or more of R¹, R², R³ and R⁴ is F,

in Formula 2, R⁵, R⁶, R⁷, R⁸, R⁹, R¹⁰, R¹¹, and R¹² may be each independently F, Cl, Br, I, or H, provided that one or more of R⁵, R⁶, R⁷, R⁸, R⁹, R¹⁰, R¹¹, and R¹² is F, and

in Formula 3, R¹³, R¹⁴, R¹⁵, R¹⁶, R¹⁷, and R¹⁸ may be each independently F, Cl, Br, I, or H, provided that one or more of R¹³, R¹⁴, R¹⁵, R¹⁶, R¹⁷, and R¹⁸ is F.

The fluorine-containing compound may include, for example, one or more selected from the group consisting of CH₃F, CH₂F₂, CHF₃, CF₄, and SF₆.

With regard to the method, the sample may be a waste gas, waste water, or a combination of the two. The contacting of the sample with the biological catalyst and ionic liquid may be performed in a liquid medium. The contacting may include mixing the ionic liquid, the biological catalyst, and the sample in any order, followed by incubation. The liquid medium may be a buffer or medium for culturing the microorganism (i.e., culture medium). When the biological catalyst is an enzyme, the contacting may include mixing the ionic liquid, the biological catalyst, and the sample in the liquid medium in any order, followed by incubation under appropriate conditions where the enzyme exerts its activity.

With regard to the method, the biological catalyst is a microorganism, and the contacting may include culturing the microorganism in a liquid medium containing the sample and ionic liquid. The culturing may be performed under conditions where the microorganism may proliferate or maintain. The culturing may be performed under medium and temperature conditions required for proliferation. For example, materials supporting the proliferation or viability of the microorganism such as nutrients may be supplied to the medium.

In some embodiments, the sample is a gas, and contacting the biological catalyst may be performed by contacting the gaseous sample with the liquid medium containing the biocatalyst and ionic liquid. That is, when the sample containing the fluorine-containing compound is gas, the contacting may be performed under conditions where the gas is in contact with the mixture or the liquid medium containing the ionic liquid and the biological catalyst and thus, in some embodiments, the gas sample or fluorine containing compound in the gas sample is at least partially dissolved in the liquid medium, thereby transferring materials between the gas-liquid interface. The contacting may be performed in a sealed or controlled sealed container. In some embodiments, the gas is introduced into a liquid medium containing the biological catalyst and ionic liquid and allowed to flow through the liquid medium. Any suitable technique for such contact may be used, such as by utilizing a sparger to introduce the gas into the liquid medium as bubbles.

The ionic liquid may be included in the liquid medium in any suitable amount to increase the rate of reduction of the fluorine containing compound in the sample. For example, the ionic liquid may be present in the liquid medium in an amount of about 10% to 60%, 20% to 50%, 30% to 50%, or 40% to 50% with respect to the total volume of the liquid medium.

A method of reducing a concentration of a fluorine-containing compound in a sample according to an aspect may be used to efficiently reduce the concentration of the fluorine-containing compound in the sample.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, the present disclosure will be described in more detail with reference to Examples. However, these Examples are for illustrative purposes only, and the scope of the present disclosure is not intended to be limited by these Examples.

### EXAMPLE 1

### Removal of CF₄ in Sample Using Phosphonium Ionic Liquid and Pseudomonas Saitens

1. Confirmation of Solubility of CF₄ for Phosphonium Ionic Liquid

5 ml of a phosphonium ionic liquid was put in a 60 ml glass serum bottle, and CF₄ was supplied to the upper empty space at a concentration of 200 ppm based on the volume of the empty space. After air-tightening by closing a lid, the bottle was incubated for 24 hours under shaking. Then, the air in the upper empty space was collected, and a concentration of CF₄ was measured using gas chromatography mass-spectrum (GC-MS). Distilled water of the same volume was used as a control group.

TABLE 1

| Ionic liquid | CF₄ reduction rate (%) |
|---|---|
| H₂O (control group) | 0 |
| [P₆₆₆₁₄]⁺ [NTf₂]⁻ | 10.9 |
| [P₂₂₂₈]⁺ [NTf₂]⁻ | 13.9 |

As shown in Table 1, when [P₆₆₆₁₄]⁺[NTf₂]⁻ and [P₂₂₂₈]⁺[NTf₂]⁻ which are phosphonium ionic liquids were used, the CF₄ concentration in the upper empty space was reduced by 10.9% and 13.9%, as compared with the control group using water, indicating that CF₄ in the upper empty space is more dissolved in the phosphonium ionic liquids than in water. In Table 1, [P₂₂₂₈]⁺[NTf₂]⁻ and [P₆₆₆₁₄]⁺[NTf₂]⁻ represent triethyl octyl phosphonium bis(trifluoromethylsulfonyl)imide and trihexyl tetradecyl phosphonium bis(trifluoromethylsulfonyl)imide, respectively.

2. Reduction of CF₄ in Sample Using Phosphonium Ionic Liquid and Pseudomonas Saitens

Pseudomonas saitens deposited with the accession number KCTC 13107BP on Sep. 12, 2016 at Korea Collection for Type Culture (KCTC) which is an international depositary authority under the Budapest treaty was cultured in the presence of phosphonium ionic liquid and CF₄, and it was examined whether the concentration of CF₄ in the sample was reduced. The strain is also called Pseudomonas saitens SF1 strain.

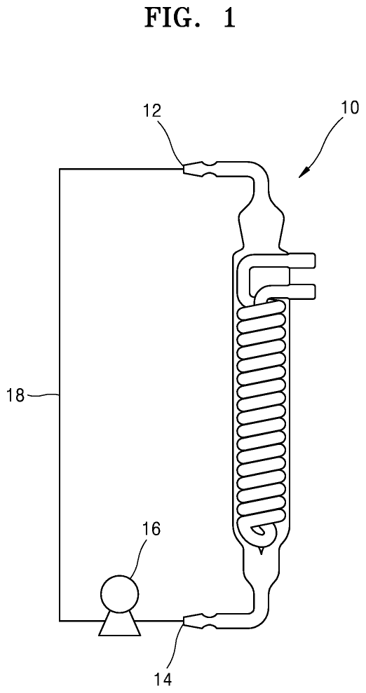

FIG. 1 is a schematic illustration of a glass Dimroth spiral condenser. As shown in FIG. 1, 40 ml of LB medium and 200 ppm of CF₄ gas were introduced into the glass Dimroth spiral condenser 10 which was sterilized at a high temperature and placed in a vertical direction (reactor length: 350 mm, external diameter: 35 mm, internal volume: 150 mL), and then LB medium was circulated. The LB medium was supplied to an inlet 12 on the top of a condenser 10, flowed through the inner wall of the condenser 10, and discharged via an outlet 14 at the bottom of the condenser 10. The discharged LB medium was re-introduced into the inlet 12 through a circulation line 18. An internal spiral tube in the condenser 10 was connected to a thermostat at 30° C., not shown in FIG. 1, to maintain the temperature. Circulation was operated by a pump 16. A circulation rate of the LB medium was maintained at 4 mL/min. After a predetermined time, i.e., 24 hours, a content of CF₄ inside the condenser was examined by GC-MS. There was no change in the CF₄ gas content.

P. saitens SF1 microorganism was seeded in the LB medium inside the condenser using a syringe at an initial OD₆₀₀ of 2.0. At this time, in the experimental group, [P₆₆₆₁₄]⁺[NTf₂]⁻ and [P₂₂₂₈]⁺[NTf₂]⁻ which are phosphonium ionic liquids were added to the medium at a volume of 20 (v/v) %, respectively. As the control group, a medium containing no phosphonium ionic liquid was only used. The control and experimental groups were cultured for about 70 hours, and the CF₄ concentration in the gas was examined by GC-MS, as described above. Results are shown in Table 2, below.

TABLE 2

| Ionic liquid | CF₄ reduction rate (%) |
|---|---|
| LB medium (control group) | 25.3 |
| [P₆₆₆₁₄]⁺ [NTf₂]⁻ | 46.6 |
| [P₂₂₂₈]⁺ [NTf₂]⁻ | 54.7 |

As shown in Table 2, when the phosphonium ionic liquid was included in the liquid medium, the CF₄ reduction rate was remarkably high, as compared with the control group. Use of [P₂₂₂₈]⁺[NTf₂]⁻ as the phosphonium ionic liquid showed a remarkably high CF₄ reduction rate, as compared with use of [P₆₆₆₁₄]⁺[NTf₂].

The CF₄ removal rates in Tables 1 and 2 were calculated from the following Mathematical Equation 1:

CF₄ removal rate=[(initial CF₄ content−CF₄ content after reaction)/initial CF₄ content]×100 <Mathematical Equation 1>

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of reducing the concentration of a fluorine-containing compound in a sample, the method comprising contacting a sample comprising a fluorine-containing compound with a biological catalyst in the presence of an ionic liquid to reduce the concentration of the fluorine-containing compound in the sample.

2. The method of claim 1, wherein solubility of the fluorine-containing compound in the ionic liquid is 300 mg/l or more.

3. The method of claim 1, wherein the ionic liquid comprises a cation selected from the group consisting of: 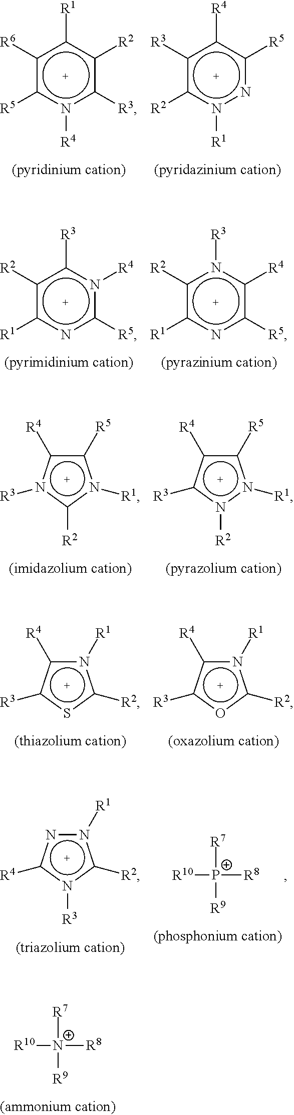
wherein, in the above formulae, R¹, R², R³, R⁴, R⁵, and R⁶ are each independently selected from the group consisting of
(i) H,
(ii) a halogen,
(iii) a —CH₃, —C₂H₅, or C3 to C25 linear, branched, or cyclic alkane or alkene optionally substituted with one or more selected from the group consisting of Cl, Br, F, I, OH, NH₂, and SH,
(iv) a —CH₃, —C₂H₅, or C3 to C25 linear, branched, or cyclic alkane or alkene comprising 1 to 3 heteroatoms selected from the group consisting of O, N, Si, and S, and optionally substituted with one or more selected from the group consisting of Cl, Br, F, I, OH, NH₂, and SH,
(v) a C6 to C20 unsubstituted aryl group, or a C3 to C25 unsubstituted heteroaryl group having 1 to 3 heteroatoms independently selected from the group consisting of O, N, Si, and S, and
(vi) a C6 to C25 substituted aryl group, or a C3 to C25 substituted heteroaryl group having 1 to 3 heteroatoms independently selected from the group consisting of O, N, Si, and S, wherein the substituted aryl group or the substituted heteroaryl group has one to three substituents independently selected from the group consisting of (1) a —CH₃, —C₂H₅, or C3 to C25 linear, branched, or cyclic alkane or alkene optionally substituted with one or more selected from the group consisting of Cl, Br, F, I, OH, NH₂, and SH, (2) OH, (3) NH₂, and (4) SH;
R⁷, R⁸, R⁹, and R¹⁰ are each independently selected from the group consisting of
(vii) a —CH₃, —C₂H₅, or C3 to C25 linear, branched, or cyclic alkane or alkene optionally substituted with one or more selected from the group consisting of Cl, Br, F, I, OH, NH₂, and SH,
(viii) a —CH₃, —C₂H₅, or C3 to C25 linear, branched, or cyclic alkane or alkene comprising one to three heteroatoms selected from the group consisting of O, N, Si, and S, and optionally substituted with one or more selected from the group consisting of Cl, Br, F, I, OH, NH₂, and SH,
(ix) a C6 to C25 unsubstituted aryl group, or a C3 to C25 unsubstituted heteroaryl group having 1 to 3 heteroatoms independently selected from the group consisting of O, N, Si, and S, and
(x) a C6 to C25 substituted aryl group, or a C3 to C25 substituted heteroaryl group having 1 to 3 heteroatoms independently selected from the group consisting of O, N, Si, and S, wherein the substituted aryl group or the substituted heteroaryl group has one to three substituents independently selected from the group consisting of (1) a —CH₃, —C₂H₅, or C3 to C25 linear, branched, or cyclic alkane or alkene optionally substituted with one or more selected from the group consisting of Cl, Br, F, I, OH, NH₂, and SH, (2) OH, (3) NH₂, and (4) SH; and
any two or more of R¹, R², R³, R⁴, R⁵, R⁶, R⁷, R⁸, R⁹, and R¹⁰ optionally form a cyclic or bicyclic alkanyl or alkenyl group.

4. The method of claim 1, wherein the ionic liquid comprises an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion.

5. The method of claim 3, wherein the ionic liquid comprises an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion.

6. The method of claim 1, wherein the ionic liquid comprises an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

7. The method of claim 3, wherein the ionic liquid comprises an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

8. The method of claim 1, wherein the ionic liquid comprises a cation selected from the group consisting of pyridinium, pyridazinium, pyrimidinium, pyrazinium, imidazolium, pyrazolium, thiazolium, oxazolium, triazolium, phosphonium, and ammonium ions; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO_{3]}⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

9. The method of claim 1, wherein the ionic liquid comprises a phosphonium cation; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

10. The method of claim 1, wherein the ionic liquid comprises triethyl pentyl phosphonium bis(trifluoromethylsulfonyl)imide, triethyl octyl phosphonium bis(trifluoromethylsulfonyl)imide, trihexyl tetradecyl phosphonium bis(trifluoromethylsulfonyl)imide, tri-n-butyl methyl phosphonium bis(trifluoromethylsulfonyl)imide, or triethyl(methoxymethyl) phosphonium bis(trifluoromethylsulfonyl)imide; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F—.

11. The method of claim 1, wherein the ionic liquid comprises triethyl octyl phosphonium bis(trifluoromethylsulfonyl)imide, tributyl methyl phosphonium bis(trifluoromethylsulfonyl)imide, or trihexyl tetradecyl phosphonium bis(trifluoromethylsulfonyl)imide; and [(CF₃SO₂)₂N]⁻.

12. The method of claim 1, wherein the biological catalyst is an enzyme or a microorganism.

13. The method of claim 12, wherein the biological catalyst catalyzes the conversion of the fluorine-containing compound into other chemicals.

14. The method of claim 12, wherein the biological catalyst is a Pseudomonas, Xanthobacter, Escherichia, or Bacillus microogranism.

15. The method of claim 12, wherein the biological catalyst is an enzyme that utilizes the fluorine-containing compound as a substrate.

16. The method of claim 1, wherein the fluorine-containing compound is a compound of any of Formulae 1 to 3:
C(R₁)(R₂)(R₃)(R₄) <Formula 1>
(R₅)(R₆)(R₇)C—[C(R₁₁)(R₁₂)]ₙ—C(R₈)(R₉)(R₁₀) <Formula 2>
S(R₁₃)(R₁₄)(R₁₅)(R₁₆)(R₁₇)(R₁₈) <Formula 3>
wherein, in the above formulae, n is an integer of 0 to 10, and when n is an integer of 2 to 10, each instance of R₁₁ can be the same as or different from each other, and each instance of R₁₂ can be the same as or different from each other,
R₁, R₂, R₃ and R₄ are each independently F, Cl, Br, I, or H, provided that one or more of R₁, R₂, R₃ and R₄ is F,
R₅, R₆, R₇, R₈, R₉, R₁₀, R₁₁, and R₁₂ are each independently F, Cl, Br, I, or H, provided that one or more of R₅, R₆, R₇, R₈, R₉, R₁₀, R₁₁, and R₁₂ is F, and
R₁₃, R₁₄, R₁₅, R₁₆, R₁₇, and R₁₈ are each independently F, Cl, Br, I, or H, provided that one or more of R₁₃, R₁₄, R₁₅, R₁₆, R₁₇, and R₁₈ is F.

17. The method of claim 16, wherein the fluorine-containing compound comprises one or more of CH₃F, CH₂F₂, CHF₃, CF₄ or SF₆.

18. The method of claim 1, wherein the sample is a waste gas or waste water.

19. The method of claim 1, wherein the sample is contacted with the biological catalyst in a liquid medium.

20. The method of claim 1, wherein the liquid medium is a buffer or medium for culturing a microorganism.

21. The method of claim 20, wherein the biological catalyst is a microorganism, and the sample is contacted with the microorganism by culturing the microorganism in a liquid medium containing the sample.

22. The method of claim 1, wherein the sample is a gas and the biological catalyst is in a liquid medium, and the sample is contacted with the biological catalyst by flowing the gas into the liquid medium.

23. The method of claim 1, wherein the biological catalyst is a dehalogenase enzyme, or microorganism that expresses a dehalogenase enzyme.

24. A composition comprising a dehalogenase enzyme, or microorgansim that expresses a dehalogenase enzyme, and an ionic liquid, optionally further comprising a fluorine-containing compound.
